(19) United States
(12) Patent Application Publication
(10) Pub. No.: US 2014/0253733 A1
(43) Pub. Date: Sep. 11, 2014

(54) NETWORKED MODULAR SECURITY AND LIGHTING DEVICE GRIDS AND SYSTEMS, METHODS AND DEVICES THEREOF

(71) Applicants: Glenn Allen Norem, Lakeway, TX (US); Steven Chien Young Chen, Potomac, MD (US); Mark Winston Hershey, Murphy, TX (US); Gary Ward Howard, McKinney, TX (US)

(72) Inventors: Glenn Allen Norem, Lakeway, TX (US); Steven Chien Young Chen, Potomac, MD (US); Mark Winston Hershey, Murphy, TX (US); Gary Ward Howard, McKinney, TX (US)

(21) Appl. No.: 14/280,387

(22) Filed: May 16, 2014

Related U.S. Application Data
(63) Continuation of application No. 13/665,974, filed on Nov. 1, 2012.

(51) Int. Cl. H04N 7/18; G06K 9/00

(52) U.S. Cl. CPC H04N 7/188; H04N 7/181; G06K 9/00771; G06K 9/00832
USPC 348/159

(57) ABSTRACT

Tracking objects with a grid of modular security and lighting devices includes triggering, based on event, a first sensor to begin capturing data of an object. In one embodiment, the first sensor is a first camera included in a first modular security and lighting device. The devices within the grid analyze captured sensor data such as first images of the object, and select, based on the analyzing, another sensor such as a second camera to begin capturing data of the object. In one example, the second camera is included in a second modular security and lighting device within the grid of modular security and lighting devices and the first and second modular security and lighting devices are located in geographically distinct locations.

The present application is a continuation of and claims the benefit of U.S. patent application Ser. No. 13/665,974, titled, “Networked Modular Security And Lighting Device Grids And Systems, Methods And Devices Thereof” to Glenn Norem et al., filed Nov. 1, 2012, which also claims priority to U.S. Provisional Patent Application Ser. No. 61/554,074, titled “Intelligent Modular Security And Lighting Device, And Systems And Methods For Use Thereof,” to Glenn Norem et al., filed Nov. 1, 2011, the disclosures of which are incorporated herein by reference in its entirety.

### BACKGROUND

A street light or security light is an elevated source of light that is usually turned on at night. Street lights may be located on the edge of roads and walkways to enable drivers and pedestrians to see better at night. Security lights may be used to illuminate a parking lot or a periphery of a building at night for security purposes. Modern street lights and security lights may have associated light-sensitive photocells to turn the lights on at dusk, off at dawn, and activate automatically when weather conditions cause ambient light levels to be reduced below a threshold light level during the day. Street lights and security lights are frequently located on dedicated poles and may also be co-located on telephone poles or utility poles. Today, street and/or security lighting typically employs high-intensity discharge lamps, e.g., high-pressure sodium (HPS) lamps that provide a somewhat yellow light source.

In general, HPS lamps provide a good amount of illumination for the electricity consumed. However, HPS lamps are not necessarily ideal for night lighting. For example, white light sources have been shown to double driver peripheral vision and increase driver brake reaction time. Newer street lighting technologies, such as street lights that employ light-emitting diodes (LEDs), emit a white light that provides relatively high levels of scotopic lumens allowing street lights with lower wattages and lower photopic lumens to replace existing street lights. However, formal specifications have generally not been written around photopic/scotopic adjustments for LED light sources, which has caused many municipalities and street departments to delay implementation of LED lighting systems until standards are updated.

Systems that employ networked cameras have been described in various literature. Networked cameras have been deployed in various locations, such as around the periphery of a building of an installation or in various locations around an installation to provide security for the building and/or installation. For example, U.S. Pat. No. 6,891,566 discloses a digital video system that includes a computer connected via a network to a number of video servers and cameras. The computer includes a program that provides a grid of display windows, each of which displays an image received from a camera associated with that window. The program sequentially polls each camera, accessing and displaying an image from the camera in its associated window. The program can access the cameras at different frame rates and stores image streams in a single file, concatenating each successive image onto an end of the file. The file is then indexed using start-of-image (SOI) and end-of-image (EOI) markers to permit fast access to individual images within the file. The program can also monitor received video and automatically start recording upon detecting motion within the video stream. Motion detection is implemented by comparing color component values for pixels from different images.

In computer networking, a wireless access point (WAP) is a device that allows wireless devices to connect to a wired network using wireless fidelity (WiFi), Bluetooth, or related standards. WAPs have been deployed in various locations, e.g., in various restaurants and coffee shops. A WAP usually connects to a router (via a wired network) or may be included in a router. A microcell is a cell in a mobile phone network that is served by a low power cellular base station that covers a limited area, e.g., a mall, a hotel, or a transportation hub. A microcell is usually larger than a picocell, although the distinction is not always clear. A microcell uses power control to limit the radius of its coverage area. Typically, the range of a microcell is less than two kilometers, a range of a picocell is 200 meters or less, and a range of a femtocell is on the order of 10 meters. A microcellular network is a radio network composed of microcells. Like picocells, microcells are usually used to add network capacity in areas with very dense phone usage, such as train stations. Microcells are often temporarily deployed during sporting events and other occasions in which extra capacity is known to be needed in advance at a specific location.

### BRIEF DESCRIPTION OF THE DRAWINGS

Embodiments of the present disclosure are described with reference to the drawings, in which like numbers represent the same or similar elements, as follows:

FIG. 1 is a view of an intelligent modular security and lighting device according to an embodiment of the present disclosure;

FIG. 2 is a bottom view of the device of FIG. 1;

FIGS. 3 and 4 schematically depict block diagrams of the device of FIG. 1 including a control unit configured according to an embodiment of the present disclosure;

FIG. 5 depicts a view of a tenon mount (housing assembly) of the device of FIG. 1 configured according to one embodiment of the present disclosure;

FIG. 6 depicts an exploded view of the tenon mount of the device of FIG. 1 according to one embodiment of the present disclosure;

FIG. 7 depicts a schematic side view of the tenon mount and fuselage of the device of FIG. 1 with optional externally mounted sensor, communication, and surveillance devices according to an embodiment of the present disclosure;

FIG. 8 depicts a schematic side view of the tenon mount and fuselage of the device of FIG. 1 with optional externally mounted sensor, communication, and surveillance devices according to another embodiment of the present disclosure;

FIGS. 9A and 9B depict different views of a front cap of a modular security and lighting device configured according to another embodiment of the present disclosure; and

FIG. 10 is a block diagram of modular security and lighting device grid including multiple modular security and lighting devices configured according to embodiments of the present disclosure.

### DETAILED DESCRIPTION OF EMBODIMENTS

The present disclosure relates generally to security devices and lighting devices and, more particularly, to a modular security and lighting device and grids of modular security and lighting devices. As described in various embodiments, modular security, lighting, and IP network access devices may be deployed singularly or in interconnected member groups (i.e., in a “grid”) to individually and collectively sense events, and where the grid shares a database-driven rules engine to collectively and programmatically respond to events detected and processed within any one or more member device.

According to one or more embodiments described in the present disclosure, a modular lighting device is disclosed that includes a tenon mount arranged and configured to receive a support tenon and an elongated fuselage coupled to the tenon mount. A controllable lighting element is coupled to the fuselage and configured to illuminate an area. The device includes a power input and communication interface configured to receive at least one of a sensor device, a surveillance device, and a communication device. A control unit is provided that may be configured to control power to and process inputs from sensor devices, surveillance devices, and/or communication devices, and/or other external or internal devices for security and lighting purposes. It should be appreciated that a tenon mount is only one mounting option and other mounting options may be utilized with a modular lighting device configured according to the present disclosure.

According to another aspect of the present disclosure, a modular lighting device includes one or more computing/processing units, a platform software operating system, application specific software, database management software, object addressing technologies, solid-state drive (SSD) memory, multimedia storage, display panels, measurement/metering systems/instruments, one or more power inputs and video, audio, and data communication interfaces configured to receive outputs from sensor devices, video and/or audio surveillance devices, and/or pedestrian, asset, and/or vehicular tracking devices, proximity one-way or two-way video and audio communications, signaling and actionable alarm components, measuring instruments, and multi-media network communication devices.

According to another aspect of the present disclosure, an intelligent grid system includes a plurality of the intelligent devices distributed over a geographic area. Real-time and historical activities and information associated with components attached to an intelligent device and/or a network of connected intelligent devices may be managed, measured, monitored, recorded, viewed, and reported.

According to another aspect of the present disclosure, a method of tracking objects with a grid of modular security and lighting devices includes triggering, based on an event, a first camera to begin capturing first images of an object. In this case, the first camera is included in a first modular security and lighting device. The method also includes analyzing the captured first images of the object and selecting, based on the analyzing, a second camera to begin capturing second images of the object. In this case, the second camera is included in a second modular security and lighting device and the first and second modular security and lighting devices are located in geographically distinct locations.

According to another aspect of the present disclosure, a modular security and lighting device grid includes a first modular security and lighting device and a second modular security and lighting device. The first modular security and lighting device includes a first camera that is triggered, based on an event, to capture first images of an object. The first modular security and lighting device is configured to analyze the captured first images of the object. The second modular security and lighting device is in communication with the first modular security and lighting device. The second modular security and lighting device includes a second camera and the first modular security and lighting device selects the second camera to begin capturing second images of the object based on the analysis of the captured first images. The first and second modular security and lighting devices are located in geographically distinct locations.

According to a different aspect of the present disclosure, a modular security and lighting device includes a tenon mount, an elongated fuselage, a pan-tilt-zoom camera, a lighting element, and control unit. The tenon mount is arranged and configured to receive a support tenon. The tenon mount is configured to receive a fisheye camera. The elongated fuselage is coupled to the tenon mount and includes a T-rail integrated into at least one external surface. The pan-tilt-zoom camera is mounted to the T-rail. The lighting element is coupled to the fuselage and is configured to illuminate an area. The control unit is configured to control the lighting element. The control unit is also configure to control the pan-tilt-zoom camera based on output from the fisheye camera.

According to yet another aspect of the present disclosure, a modular communication and lighting device includes an elongated fuselage, a lighting element, a control unit, and a communication device. The lighting element is coupled to the fuselage and is configured to illuminate an area. The control unit is configured to control the lighting element. The communication device forms an access point for one or more of, for example, wired PoE, IP to Coax, Coax to IP, secure wireless WiFi (e.g., ZigBee), secure wireless BH (back haul), WiFi, 3G, 4G, secure wireless AP (access point), dual independent networks (e.g., public works networks), code division multiple access (CDMA), spread spectrum wireless, orthogonal frequency division multiplexing (OFDM), 1G, 2G, 3G, 4G wireless, Bluetooth, Infrared Data Association (IrDA), shared wireless access protocol (SWAP), wireless fidelity (WiFi), WIMAX, and other IEEE standard 802.11-compliant wireless local area network (LAN), 802.16-compliant wide area network (WAN), and ultrawideband (UWB) networks, and microcell, picocell, and femtocell of a mobile phone network. A modular communication and lighting device may be part of a communication platform, e.g., a WiFi AP or a microcell (e.g., a small cell or a metrocell).

Grids of such devices may be employed to increase coverage area in stadium complexes, entertainment venues, or wherever there are large concentrations of users (particularly transient users) where the grid of devices can deliver concentrated local network access or, when user concentration is temporary, alleviate cellular or broadband traffic congestion. As a communications platform, a lighting system can support a public safety network, land mobile radio, long-term evolution (LTE), or other narrowband or broadband wireless communication access devices, WiFi hotspot devices, wired (cable, or fiber) devices and be interconnected with other broadband Internet or private-network deployments (e.g., cable TV, Verizon Fios/AT&T Uverse, or any local IWP). The lighting device can also support SCADA applications for administering and performance monitoring of utility infrastructure (e.g., electric meter reading, water treatment process facilities, etc).

In describing example embodiments in detail below, specific terminology is employed for the sake of clarity. It should be appreciated that the invention, which is defined by the claims and their equivalents, is not intended to be limited to the specific terminology selected. A person skilled in the relevant art will recognize that other equivalent components can be employed and other methods developed without departing from the broad concepts of the invention.

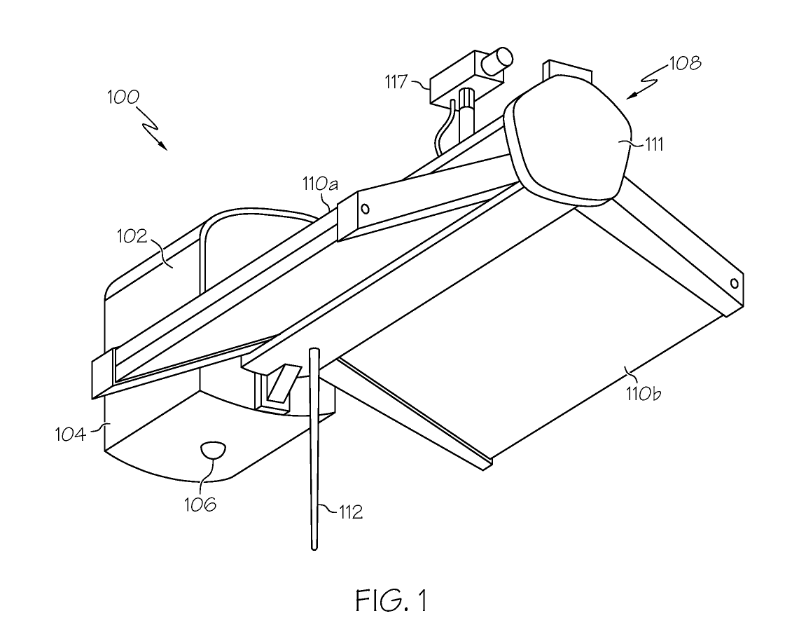

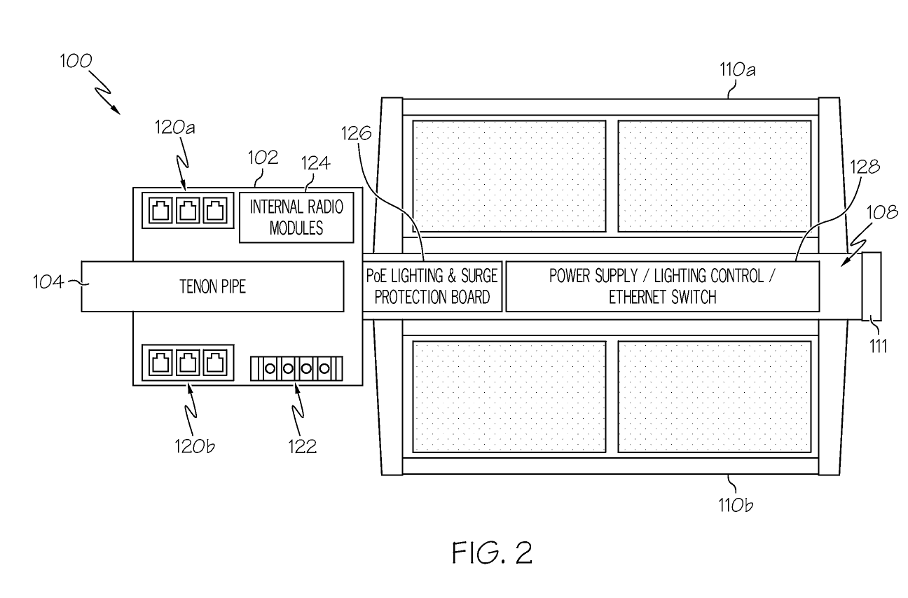

With reference now to the figures, FIG. 1 depicts a modular security and lighting device 100 configured according to embodiments of the disclosure. The device 100 includes a tenon mount (housing assembly) 102, a surveillance device 106, a central elongated fuselage 108, one or more lighting elements 110a, 110b, and one or more antennas 112 for communication devices (not separately shown in FIG. 1). The device 100 is also illustrated as including a pan-tilt-zoom camera 117. The surveillance device 106 may, for example, be a fisheye camera that provides an output that is used to control the pan-tilt-zoom camera 117 to obtain additional details on an object of interest. For example, the object of interest may be a vehicle and the additional details may include a license plate number of the vehicle and a facial image of a driver of the vehicle. The tenon mount 102 may be configured to receive and be reversibly secured to a tenon (tenon pipe) 104 (see FIG. 2) such as, for example, a substantially horizontally extending support tenon (e.g., of a streetlight) on which the device 100 is being retrofitted. The one or more lighting elements 110a, 110b may be, for example, lighting panels permanently fixed to lateral elongated sides of the fuselage 108. Alternatively, the one or more lighting elements 110a, 110b may be, for example, modular lighting panels arranged and configured to be reversibly coupled to and decoupled from (mechanically and/or electrically) lateral elongated sides of the fuselage 108. In one or more embodiments, the device 100 includes one or more light-emitting diode panels and a camera whose view is substantially centered with an illumination pattern provided by the one or more light-emitting diode panels.

The panels 110a, 110b may be angularly fixed or pivotable relative to the fuselage 108 and to one another. Each panel 110a, 110b may include a plurality of lights mounted thereon such as, for example, controllable light-emitting diodes (LEDs), for human visible or non-visible lighting sources (e.g., infrared LEDs). The LEDs may be mounted on panels 110a, 110b at different positions and angles relative to a mounting surface to define different light projection planes for maximum illumination over a wide area. Panels can be mixed and matched to provide both visible and invisible light that can only be detected by night vision glasses or infrared cameras. A removable end cap 111 may be provided at the end of the fuselage 108 to allow access to an interior of the fuselage 108 when removed and/or to hold the panels 110a, 110b in place if the panels are detachable. While each of the foregoing elements are shown in FIG. 1 as being physically positioned within, or on, one of the tenon mount 102 and fuselage 108, such positioning is not required and in alternative embodiments one or more such elements may be physically repositioned depending on design constraints or otherwise.

FIG. 2 depicts a bottom view of the device 100 showing the tenon 104 received and secured within tenon mount 102. The device 100 may include a number of internal and/or external power, communication, electrical protection, and/or control elements arranged within and along the tenon mount 102 and/or fuselage 108, as desired. For example, the device 100 may include a power input and communication interface including a wired or wireless local area network/wide area network (LAN/WAN) interface, such as, for example, an Ethernet interface 120a and 120b. The device 100 may also include AC power connections 122 and optional internal radio modules 124. The device 100 may also include universal serial bus (USB), RS-232, dry-contact closure, and analog 0-10 Volt DC (Vdc) inputs. The device 100 may further include a lightning and surge protection board 126, a photocell sensor interface board (not shown in FIG. 2), and a power supply/lighting control/Ethernet switch control unit 128. The photocell sensor interface board may be configured to detect whether a photocell (not shown in FIG. 2) on the device 100 is on or off and may communicate the status of a photocell to the power supply/lighting control/Ethernet switch unit 128 to power on/off the lighting panels 110a, 110b without disturbing power to other electronics, e.g., sensor and communication devices. The power supply/lighting control/Ethernet switch unit 128 may include, for example, an Ethernet switch/router. While each of the foregoing power, communication, electrical surge protection, and control elements are shown in FIG. 2 as being physically positioned within, or on, one of the tenon mount 102 and fuselage 108, such positioning is not required and in alternative embodiments one or more such elements may be physically repositioned depending on design constraints or otherwise.

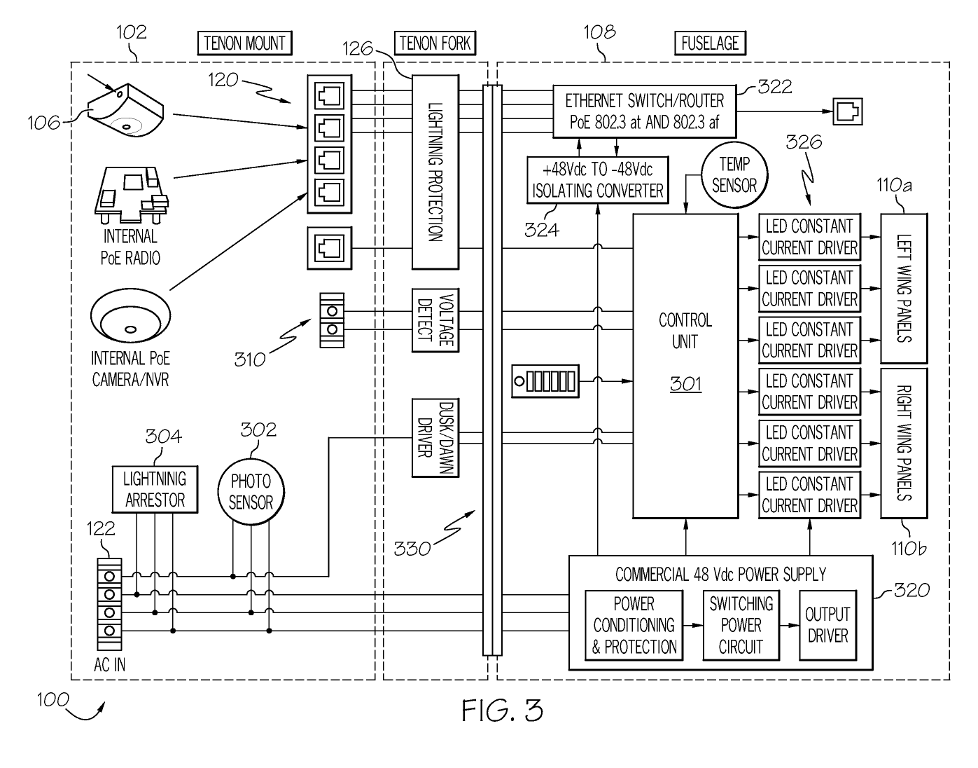

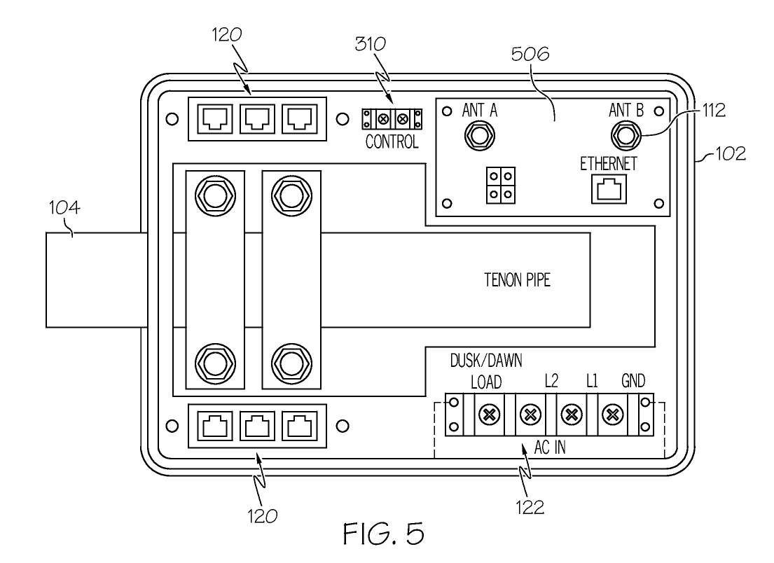

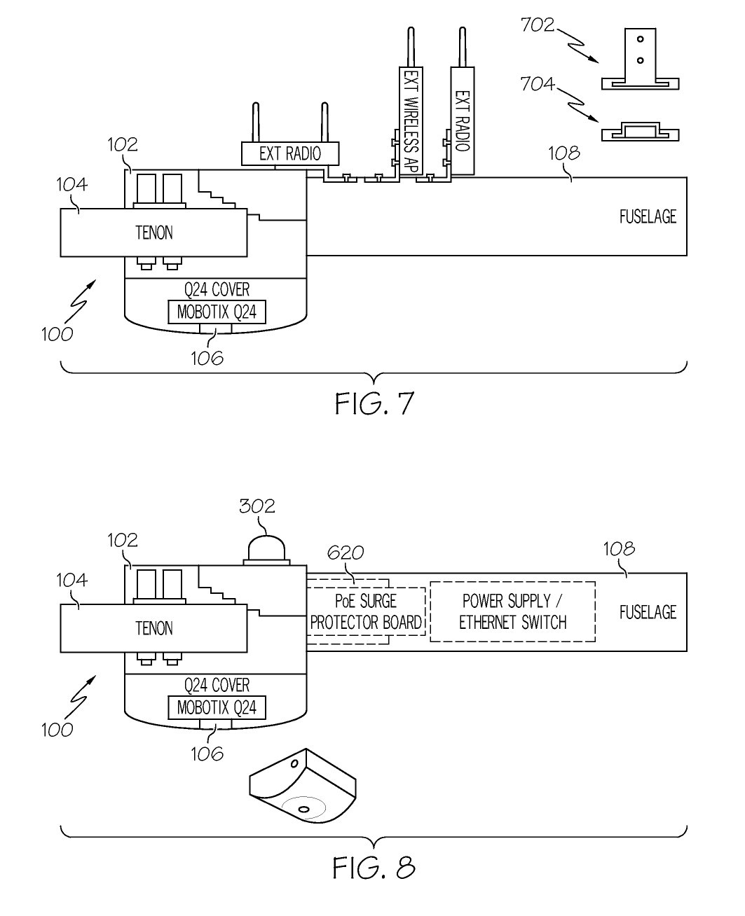

FIGS. 3 and 4 schematically depict block diagrams of embodiments of the device 100 of FIG. 1 including sensor devices, communication devices, surveillance devices, and lighting elements coupled to a control unit 301 (which may take the form of the power supply/lighting control/Ethernet switch unit 128). For example, the device 100 may include the tenon mount 102 mechanically connected to the fuselage 108 via a tenon fork member (see FIGS. 6 and 8). The tenon mount 102 may include AC power connections (AC IN 122) and an Ethernet interface 120, as described above and shown in FIG. 2. The Ethernet interface 120 may include, for example, one or more Power over Ethernet (PoE) LAN connection points (e.g., 802.3 at/af), a power supply WAN (e.g., isolated Ethernet I/O), and an unpowered Ethernet switch WAN (e.g., wired or backhaul radio). The one or more powered Ethernet connection points may be configured to receive, for example, outputs from one or more sensor devices, communication devices, and/or surveillance devices. A contact closure input 310 may also be provided to allow programmable control or remote control input of the lighting elements through a network (e.g., dimming). A lightning arrestor 304 and a photo sensor 302 may be coupled to AC IN 122.

As shown in FIGS. 3 and 4, the control unit 301 may be optionally disposed in fuselage 108 along with other components. For example, the control unit 301, a power driver 320 (e.g., commercial power supply), an Ethernet switch/router 322, and a voltage isolation converter 324 may be included in fuselage 108. The power driver 320 may include power conditioning and protection circuitry, a switching power circuit, and an output driver. The power driver 320 may be coupled to the control unit 301. The power driver 320 may also be coupled to the Ethernet switch/router 322 through the voltage isolation converter 324. The power driver 322 may also be coupled to one or more lighting (e.g., LED) constant current drivers 326 coupled between the control unit 301 and the lighting elements 100a, 100b which may be, for example, LED panels.

The components in the tenon mount 102 may be coupled to the components in the fuselage 108 via a bulkhead connector 330. The one or more powered Ethernet LAN connection points and unpowered Ethernet switch WAN may be coupled to the Ethernet switch/router via lightning protection and surge protection board 126. The power supply WAN may also be coupled to the control unit 301 via the lightning protection and surge protection board 126.

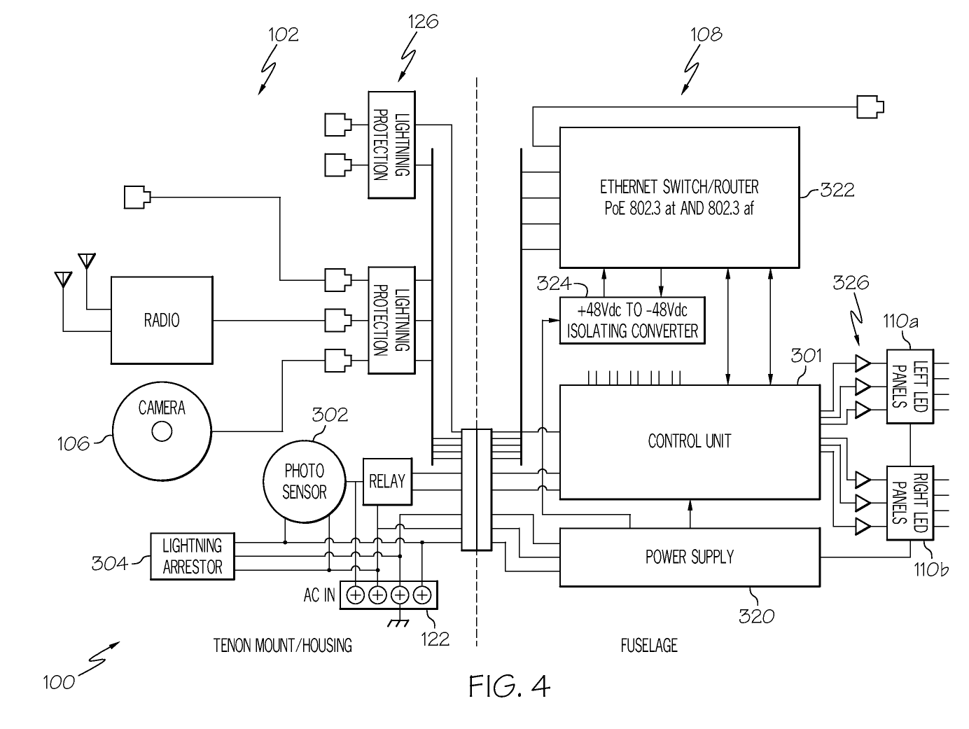

FIG. 5 depicts a view of a portion of a power input/output and communication interface arranged within, for example, a tenon mount 102 (housing assembly) of the device 100 of FIG. 1 according to an illustrative embodiment. As shown in FIG. 5, the tenon pipe 104 may be received in the tenon mount 102 and reversibly secured by one or more brackets. The Ethernet interface 120 may include internal LAN Power-over-Ethernet (PoE) connections, a WAN connection, and isolated lighting LAN as described above. Also shown are the previously described AC power connection 122, contact closure input (e.g., panic button on call box or streetlight pole) 310, and an optional internal communications device/module (e.g., WiFi module equipped with a PoE adapter) 506.

FIG. 6 depicts an exploded view of the tenon mount (housing assembly) 102 of the device 100 of FIG. 1 according to an illustrative embodiment. The tenon mount 102 may include an outer shell 601, support bracket 602, gasket 603, cover portion 604, bird guard 605, top door 606, terminal block 608 (for AC IN power), clamp part 609, and a plurality of miscellaneous fasteners 607, 610, 611, 612, 614, 616, and 617 (e.g., screws, bolts, rivets, washers, nuts, etc.) for constructing the tenon mount 102. A tenon fork 620 may be provided for mechanically coupling the tenon mount 102 to the fuselage 108 (see FIG. 8).

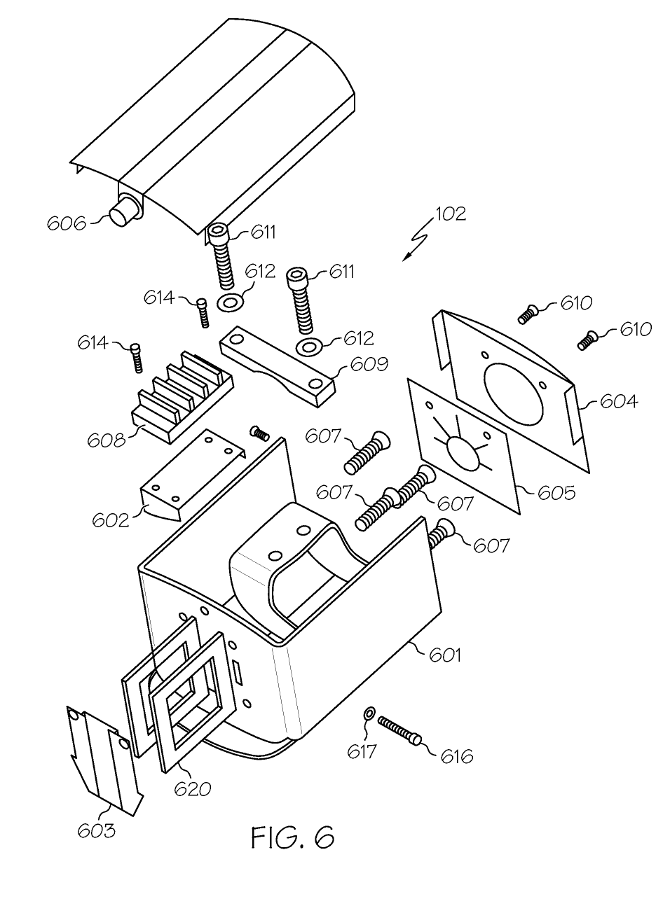

FIGS. 7 and 8 depict side views of the tenon mount 102 and fuselage 108 of the device 100 of FIG. 1, which may include T-slots 702 and 704 for optional externally mounted sensors, communication devices, and surveillance devices. As shown in FIG. 7, T-slots 702 and 704 may be provided on one or both of the top and bottom of the fuselage 108 for receiving externally mounted devices (e.g., external radios and external wireless access point, as shown) having complementary attachment structures (e.g., DIN rail). As depicted in FIG. 8, a dusk-to-dawn photocell sensor 302 may optionally be coupled to the tenon mount 102 and connected to one of the powered inputs. The tenon fork 620 is further illustrated in FIG. 8 coupling the tenon mount 102 to the fuselage 108.

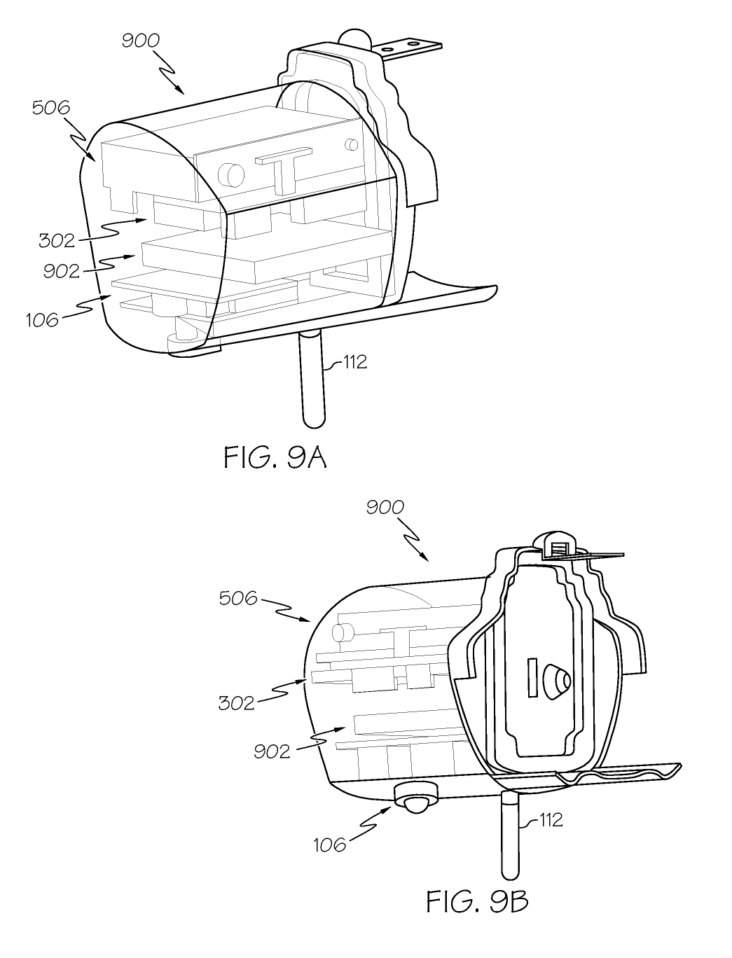

FIGS. 9A and 9B depict different views of an end cap 900 for a modular security and lighting device configured according to another embodiment. As is illustrated, end cap 900 includes a control unit 301, a surveillance device 106, a communication device 506, an antenna 112 for the communication device 506, solid-state drive (SSD) memory 902, and may include additional sensor devices, surveillance devices, and/or communication devices. In various embodiments, the end cap 900 is configured to be coupled to the fuselage 108 of the device 100 (see, for example, FIGS. 1 and 2).

Sensor devices as described herein may include detector devices such as a photocell sensor/detector, a dusk-to-dawn sensor, a motion sensor, a light sensor, a temperature sensor, a weather sensor (e.g., configured to detect wind, rain, temperature, relative humidity, heat index, wind chill, barometric pressure, dew point, wet bulb, etc.), a video and/or image sensor (e.g., a video camera), an infrared sensor (e.g., an infrared camera), a chemical sensor, a biological sensor, a radiation sensor, a nuclear sensor, an explosives sensor, a radio frequency identification device and/or sensor (RFID), a temperature sensor, a pressure sensor, a sound sensor (e.g., a gunshot detector), or combinations thereof. Sensor devices have the capability to sense an event or object within a field of detection of the sensor device that is defined by the specifications and sensitivities of the device. For example, a video/still camera device has a field of detection defined by its field of view, magnification, resolution, focal length, aperture size, zoom range, shutter speed, facial recognition functions, etc.

Surveillance devices as described herein may include devices such as, for example, a camera, a still camera, a digital camera, a video camera, an integrated video camera (e.g., a Mobotix Q24), a fixed focus 360 degree hemispheric view (fisheye) video camera, a single or dual fixed lens dome video camera, a pan-tilt-zoom camera, a high resolution (Internet protocol) IP video camera, a Network Video Recorder/IP (NVR/IP) camera with on-board motion or event triggered digital video recording, one way audio devices including speakers or public address devices, two way audio devices including microphones, or combinations thereof. An internal audio and/or video storage device may be provided such as, for example, an internal digital network video recorder device (NVR) with memory storage. The NVR may store multi-day video/audio data including date-time-location stamp. For example, the location information may be provided in the form of global positioning system (GPS) data. The NVR device may be programmable to be triggered upon activation by a sensor (e.g., a motion sensor or other sensor device).

Communication devices as described herein may include wired and wireless networking and communication devices, interfaces and/or technologies for communicating in and to one or more networks, including, for example, wired PoE, IP to Coax, Coax to IP, secure wireless WiFi (e.g., ZigBee), secure wireless BH (back haul), WiFi, 3G, 4G, secure wireless AP (access point), dual independent networks (e.g., public works networks), code division multiple access (CDMA), spread spectrum wireless, orthogonal frequency division multiplexing (OFDM), 1G, 2G, 3G, 4G wireless, Bluetooth, Infrared Data Association (IrDA), shared wireless access protocol (SWAP), wireless fidelity (WiFi), WIMAX, and other IEEE standard 802.11-compliant wireless local area network (LAN), 802.16-compliant wide area network (WAN), and ultrawideband (UWB) networks, and microcell, picocell, and femtocell wireless networks. Security of communications to/from the aforementioned devices may include standards such as, for example but not limited to, standard wireless encryption protocol (WEP) for WiFi, advanced encryption standard (AES), and FIPS 140-2.

The device 100 may be retrofitted to existing powered support structures such as, for example, streetlights positioned along roads, sidewalks, perimeters, buildings, parking lots, airports, private and public access areas, college and other educational campuses, military installations, and the like. A plurality of devices 100 may be employed in a networked system such as, for example, a grid or mesh system over a geographic area. The grid or mesh system may be, for example, in the form of a hub and spoke configuration.

Device 100 may include input/output (I/O) devices such as, for example, communications interface, cable and communications path, etc. These devices may include, for example, a network interface card and modems (not shown). Communications interface may allow software and data to be transferred between device 100 and external devices. Examples of communications interface may include, for example, a modem, a network interface (such as, e.g., an Ethernet card), a communications port, a Personal Computer Memory Card International Association (PCMCIA) slot and card, a transceiver, a global positioning system receiver, etc. Software and data transferred via communications interface may be in the form of signals which may be electronic, electromagnetic, and optical or other signals capable of being received by communications interface. These signals may be provided to communications interface via, for example, a communications path (e.g., a channel). This channel may carry signals, which may include, for example, propagated signals, and may be implemented using, for example, wire or cable, fiber optics, a telephone line, a cellular link, a radio frequency (RF) link and other communications channels, etc.

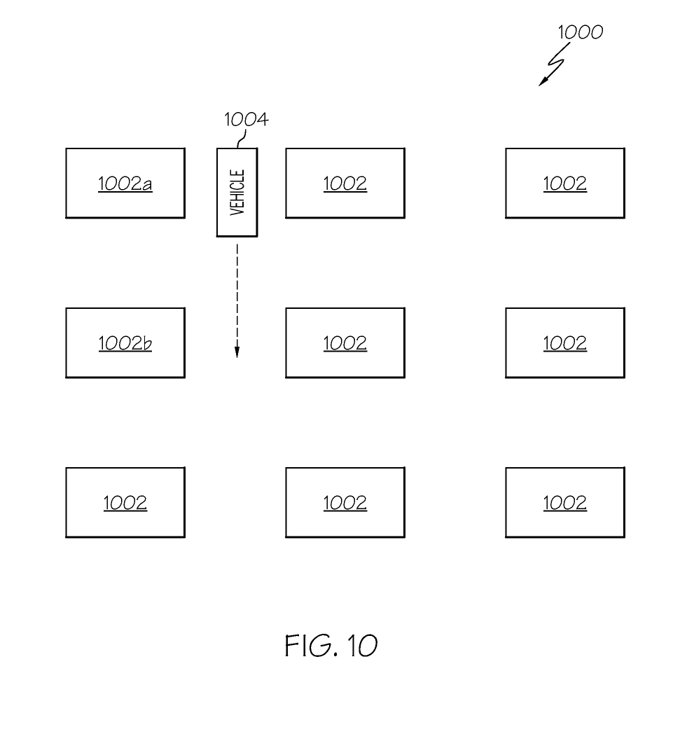

With reference to FIG. 10, a modular security and lighting device grid 1000 includes a number of modular security and lighting devices 1002 that are located at geographically distinct locations. The devices 1002 may be, for example, deployed on street corners throughout a city. For example, devices 1002 may take the form of device 100 and be deployed on various light poles, telephone poles, and/or power poles in desired locations. According to one or more embodiments of the present disclosure, a first modular security and lighting device 1002a includes a first camera (e.g., a fisheye camera) that is triggered, based on an event, to capture first images of an object (e.g., a vehicle) 1004. For example, the event may correspond to a sensor device of device 1002a detecting one of a chemical, biological, radiation, nuclear, and explosive hazard associated with the object 1004. In this case, the first camera is triggered to begin capturing first images of the object 1004 in response to the sensor device detecting at least one of a chemical, biological, radiation, nuclear, and/or explosive hazard associated with the object 1004.

In one or more embodiments, the device 1002a is further configured to analyze the captured first images of the object 1004 and communicate (using a communication device) with one or more modular security and lighting devices in the modular security and lighting device grid 1000, for example second modular security and lighting device 1002b, that is in a path of the object 1004. In an embodiment, device 1002a analyzes the captured first images of the object 1004 and communicates to a second modular security and lighting device 1002b projected to be in a path of the object 1004. The device 1002b includes a second camera that is configured to, based on a communication from the device 1002a, begin capturing second images of the object 1004. For example, when a device 1002 determines from analyzing the images of an object that the object is traveling in a particular direction, the device 1002 may communicate with known devices 1002 in a projected path of the object, such that the known devices 1002 are prepared to capture images of the object when the object travels past the devices 1002. As one example, a device 1002 may identify an object to another device 1002 with a capture signal that includes one or more metatags for the object.

The devices 1002 may each include multiple cameras. For example, a device 1002 may include a fisheye camera and a pan-tilt-zoom camera that is controlled to obtain additional details on an object based on an output of the fisheye camera. As one example, the object may be a vehicle and the additional details may include a license plate number of the vehicle and/or a facial image of a driver of the vehicle. In various embodiments, images captured by a camera of devices 1002 are location, time, and date stamped. The captured images may be stored in a non-volatile memory of the devices 1002 for analysis by the devices 1002 and/or for later transmission to a central location (repository) for additional analysis and/or long-term storage (for example, in the event future analysis is desired). In one or more embodiments, the devices 1002 each include one or more light-emitting diode panels and a camera whose view is substantially centered with an illumination pattern provided by the one or more light-emitting diode panels.

When a plurality of devices (100, 1002) are employed in a networked system such as, for example, a grid and/or mesh system over a geographic area, for example, modular security and lighting device grid 1000, the grid may be a surveillance grid, a sensor grid, a communication grid, a campus grid, a RFID grid, a messaging grid, or a combination thereof. In a sensor grid, modular security and lighting device grid 1000 may be configured as a wireless sensor network (WSN) consisting of spatially distributed autonomous sensors to monitor physical or environmental conditions, such as temperature, sound, pressure, etc. and to cooperatively pass their data through the network to a main location. In a surveillance grid, each device may include video cameras and/or audio surveillance devices, digital network video recorders, compression and encryption processors, multi-day media storage devices, platform-based image/audio analytic processors for applications including motion sensing, object/facial recognition, object left behind, etc.

In a sensor grid, each device (100, 1002) may include direct mounting/platform integration of sensors and/or wired/wireless communications with sensors and/or sensor arrays, for detection of chemical, biological, radiation, nuclear, and explosive (CBRNE) hazards, housekeeping status monitoring, calibrations, sensor asset tracking, responses to alarms, etc. In contrast with current security implementations, which focus on detection at the entrance to a critical infrastructure, a surveillance and/or sensor network over a large area (e.g., many city blocks around the critical infrastructure such as a government office) may provide early detection and advanced warning for powerful bombs or chemical agents.

Network connectivity “backhaul” may also be possible for surveillance and sensor grids. For example, the devices can be configured with multiple TCP/IP wireless devices (e.g., radios). A standard internal radio may typically be used to create local mesh interconnectivity for the grid. All devices in the local mesh would be similarly configured and interconnected as a mesh network group. One device such as, for example, the unit most centrally located in the mesh group, may be configured with a second, external radio to backhaul video, audio, and/or sensor data to a central location from any or all of the mesh-connected devices. In this way a high-bandwidth connection can be shared by a number of devices in the mesh group.

Any grid system may include integration of wire, wireline (e.g., Ethernet over powerline), PoE, and/or wireless communications modules. This may assist in voice, data and video transmission for surveillance grids. Real-time voice, data and video communications may be enabled for campus grids, which may include panic buttons, microphones, speakers, cameras mounted on poles and/or the device and managed by the processing unit to provide one way public address messaging, two way audio/video/data communications with pedestrians on a campus, and communications with and monitoring, management, tracking, etc. of pedestrians, vehicles and assets on the campus. Computer Aided Dispatch (CAD), Video Management System (VMS), or Public Safety Incident Management (PSIM), may be utilized to control the individual lighting elements of each device 100 and/or banks of lights and/or all of the lights in a grid on campus to warn of an incident or impending event (e.g. severe weather or violent behavior alerts).

The grid system may enable and improve voice, data and video transmission for communicating with first responders and public works personnel, vehicles, and assets via “Public Safety Communication Grids” (e.g., including, e.g., M2M, broadband, etc.). The grid system may enable and improve voice, data and video transmission with microcell, picocell and femtocell location placement, management, and support for the mobile “telecom” service providers (e.g., “MobileComm Grids”), cable companies, or associated infrastructure “tower or distributed antenna system (DAS)” providers. The grid system may enable and improve voice, data and video transmission with Wi-Fi, WiMax, etc. “hotspot” location placement, management, and support for the wireless broadband service providers or infrastructure providers (e.g., “Hotspot Grids”). The grid system may enable and improve data communications with RFID tags/badges with readers/transmitter location placement, subscriber and asset management, and support for pedestrians/guests/clients at a sporting venue, a retail outdoor mall or convention campus or complex.

The grid system may facilitate and improve communications with and monitoring, management, tracking, etc. of pedestrians, vehicles, and assets for crowd activity/traffic monitoring and management, plus (e.g., lost child, lost article, fire, medical emergency, etc.) panic response coordination (e.g., “RFID Grids”). The grid system may enable and improve distributed databases for the administration of authentication, authorization, and delivery of voice, text, data, or video messages to individuals, vehicles, or assets (e.g. encryption key management, authorized access to the Messaging Grids, delivery of warnings or advertising or coupons to select subscribers via their mobile devices and/or computers.

College and university campus environments present unique opportunities for the devices (e.g., individually and in a grid system), integrating traditional security surveillance features with the critical need for campus-wide personal security. The devices may seamlessly integrate with distributed emergency callbox devices, with alert/emergency notification systems, with fire control systems, with personal emergency event/dispatch systems, and with a wide variety of mobile devices (e.g., smart phones, tablets, etc.) equipped with personal security applications that can pinpoint location and cause nearby devices to activate and interact with emergency management teams and other private and public first responder organizations' communication systems. All integrated features of the device, e.g., lighting brightness management, lighting flash alerting, audio multi-node public address, two-way conversational audio, motion detection (e.g., IR and video), Emergency Call Button processing, etc., become integral parts of a comprehensive emergency response system. In addition, those devices equipped with WiFi, LIE, microcell, and/or other wireless options can be deployed as hotspots for more complete WiFi, broadband wireless or other voice, data, or video communications coverage across the campus.

Each device (100, 1002) may integrate discrete technologies (sensors, communication devices, surveillance devices, etc.) into an intelligent platform including intelligent backplane, intelligent power supply with, for example, PoE and other voltage drops for the integrated elements and electronic subsystems (e.g., media and data storage, I/O, and both broadband and low-bandwidth communications), and one or more processing units (e.g., CPUs or controllers). When communicating, each device (100, 1002) may use one or more specific identifying attributes such as, for example, its location, for example its GPS coordinates, as a naming convention, where every frame (e.g., stored or compressed packet) of video data and/or audio data and/or other data processed by the device carries at least the location-based naming convention of the device for location-based integrity plus data handling validation. Data that is processed by the device may include data that originates at the device, is stored by the device, and/or is handled or transmitted by (e.g., passed thru) the device. Time synchronized and location aware recording and play back with built-in real-time clock from sources such as a GPS and time synchronized network may be provided. Geo-spatial addressing schemes may also apply to the components, sensors, or other assets that are physically or logically connected to and/or managed by the device or a network of devices; and may include persons, assets, vehicles, and other objects or activities that are in the jurisdiction of the device for the identification, monitoring, management, control, tracking, or other information gathering activity or performance status or for make, model, manufactures' data and calibration record management.

The devices (100, 1002) can be equipped with Ethernet-based RFID sensors which can detect the presence of nearby tagged equipment, personnel, vehicles, or other assets or resources. When deployed in a blanket coverage configuration (e.g., a grid), the tagged asset, person or resources can be effectively identified, located, tracked, and monitored anywhere within the grid. This enables individual, as well as crowd and traffic management activities.

The devices 100 may be interconnected as a mesh network to offer wide-area blanket TCP/IP coverage that can interconnect and provide a communications backbone for other devices that communicate using the same Ethernet standards. This includes message boards, reader boards, and other text and graphics-display devices. The devices, via external PoE ports, offer a convenient way to mount and drive such display devices along pedestrian walkways, in large-area campuses, parks, parking lots, or other locations previously considered too impractical or costly for such deployments.

The described embodiments (or any part(s) or function(s) thereof) may be implemented using hardware, firmware, or a combination of hardware and software that may be implemented in one or more computer systems or other processing systems. In one exemplary embodiment, the invention may be directed toward one or more computer systems capable of carrying out the functionality described herein. The computer system may include one or more processors, such as, for example, included in the control unit 301 shown in FIGS. 3-4. The processor(s) may be connected to a communication infrastructure (e.g., a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Unless specifically stated otherwise, as apparent from the foregoing discussions, it should be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses and/or devices for performing the operations herein. An apparatus may be specially constructed for the desired purposes, or it may comprise a general purpose device selectively activated or reconfigured by a program stored in the device. In yet another exemplary embodiment, the invention may be implemented using a combination of any of, e.g., but not limited to, hardware, firmware, and software, etc. The exemplary embodiment of the present invention makes reference to, e.g., but not limited to, communications links, wired, and/or wireless networks. Wired networks may include any of a wide variety of well known means for coupling voice and data communications devices together. A brief discussion of various exemplary wireless network technologies that may be used to implement the embodiments of the present invention now are discussed. The examples are non-limiting. Exemplary wireless network types and communication device types may include, e.g., but not limited to, code division multiple access (CDMA), spread spectrum wireless, orthogonal frequency division multiplexing (OFDM), 1G, 2G, 3G, 4G wireless, Bluetooth, Infrared Data Association (IrDA), shared wireless access protocol (SWAP), wireless fidelity (WiFi), WIMAX, and other IEEE standard 802.11-compliant wireless local area network (LAN), 802.16-compliant wide area network (WAN), and ultrawideband (UWB) networks, etc. Also included may be a dedicated public safety wireless network (PSWN) such as, for example, a local, statewide, or nationwide mobile broadband network for emergency services (e.g., in the D Block 700 MHz band).

The exemplary embodiments of the present invention may make reference to WLANs. Examples of a WLAN may include a shared wireless access protocol (SWAP) developed by Home radio frequency (HomeRF), and wireless fidelity (WiFi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including wireless LANs compliant with IEEE std. 802.11a, b, d, g, or n, such as, for example, IEEE std. 802.11a, b, d, g and n (including, for example, IEEE 802.11g 2003, etc.), etc.

In one or more embodiments, video and audio capture, event-action processing, Internet protocol (IP) communications, power over Ethernet (PoE) power negotiation, Ethernet communication, and light-emitting diode (LED) lighting may be employed within a lighting device configured according to the present disclosure. In general, arc lights do not dim and cannot be dimmed. In contrast, LED lights may be set to a desired light level that is optimal for video recording and may implement a midnight dimming feature that corresponds to a preset dim level. For example, according to the present disclosure an LED array may be optimized for spectral purity and designed specifically for video recording and/or be configured to be field-adjustable for optimization of a light coverage area. In general, arc lights can be turned on or off, cannot be dimmed, and if turned off cannot be restarted until after a cool-down period.

According to the present disclosure, an LED light may be controlled to facilitate instantaneous control/response to lighting level commands (both self-contained lighting and other networked lights) and may be controlled to provide flash and strobe modes for security applications. In various embodiments, a lighting device is configured with event-action processing logic. A lighting device may integrate surveillance with self-controlled lighting and may directly associate sensor detection with controlling a self-contained light or any number of networked lights. While there are VMS systems that respond to motion or other sensor-driven triggers, none of the VMS systems control lighting and/or are capable of being programmed to associate sensed events with lighting actions. While known driveway motion detectors are known that can turn on an associated light, known driveway motion detectors have only utilized passive infrared (PIR) sensors. In contrast, according to various disclosed embodiments, a lighting device controls lighting (and other actions) based on a trigger that is provided from a sensor.

According to one or more aspects, outdoor LED lights and outdoor PoE switches are integrated within a lighting device. For example, a lighting device configured according to the present disclosure may included a light controller and Ethernet switch controller deployed as a single device (e.g., implemented on a single printed circuit board (PCB) using a single microprocessor) with a single IP address that facilitates provisioning the lighting device to respond to specific IP-delivered lighting commands, monitor lighting and system performance, and report on system performance, all via a PoE switch. In one or more other embodiments, XMPP may be employed as the protocol for cloud-based and point-to-point alert traffic for a lighting device.

A lighting device grid may include multiple lighting devices that are in communication with a server that identifies any devices (e.g., sensors, cameras, etc.) on the grid to provide interoperability with automatic provisioning of the devices. In various embodiments, a lighting device may be employed to extend a detection range city blocks or miles from a protected location. For example, a lighting device my provide early detection for explosives or dirty bombs that are directed at an installation, as contrasted with performing detection at a gate of the installation where it may be too late to prevent damage to the installation. According to another embodiment, a lighting device may be configured for both security and energy saving. As one example, a lighting device grid can detect and pinpoint power outages over a large area.

A lighting device may also be configured for weather sensing to facilitate micro-weather forecasts. A lighting device may be configured with road condition and traffic sensors for intelligent traffic management. A lighting device may be configured to perform license plate recognition for parking metering. A lighting device may also be configured to confuse attackers of an installation with sound, lighting, etc. to gain response time during a detected attack. Various events may be employed as a precursor to an actions. For example, an event may correspond to: a trigger (e.g., object motion); a logical association of motion events (such as transition from area 1 to area 2 exclusive of transitions from area 2 to area 1, i.e., a direction event); a callbox button actuation; a contact closure input; a trigger associated with an incoming IP message; a temperature that is above a high temperature level or below a low temperature level; an ambient light level that is too bright or too dim; a sound louder than a programmed threshold; or an object that crossed a virtual line.

A programmed action may include: flashing and/or strobing lights; setting a light level to a desired value; transmitting a video snapshot; playing sounds and canned messages; transmitting motion clips with sound; placing an SIP call, transmitting FTP video or video-with-audio clips, sending a short message service (SMS) message; transmitting an IP message to other devices (e.g., to trigger actions or action lists on other lighting devices within a grid of lighting devices); turning lights on or off or dimming lights; transmitting an IP message to any 3rd-party system (e.g., a VMS system); turning on, off, or pulsing relays (e.g., a callbox option or external input/output (EXT/I/O) option); and/or calling a video phone to initiate a two-way conversation with audio and video. In one or more embodiments, a lighting device may implement an action list that groups actions for execution (e.g., sequentially or simultaneously) when triggered by an associated event. For example, simultaneous execution of actions in an action list may be selected whenever all actions are to be executed at the same time (e.g., turn on a group of lights all at once, or send video clips to several email addresses at once). Sequential action of action in an action lists causes a first action to be executed, followed by a next action, etc. It should be appreciated that actions that fail in some way may be skipped or halted. For example, the placing of additional SIP outcalls to a list of phone numbers may be terminated when a call is answered successfully.

According to one or more aspects of the present disclosure, LEDs of a lighting device may be age compensated. For example, LED drive levels may be increased to compensate for decreased light output due to age. In various embodiments, a lighting device is equipped with a microprocessor-based lighting control module that controls LED light panels via IP commands. In at least one embodiment, a lighting control module includes a built-in Web server that provides system management, turns lighting on and off, and controls LED brightness level by direct control of LED illumination. A lighting device may be configured to automatically control lighting functions for a host light, as well as one or more lighting device slave units in a local or wide-area network. In various embodiments, automation features of a lighting device are based on trigger events that execute a programmed, configurable list of actions. As previously mentioned, triggers may include motion detection, callbox button actuation, contact closures from external devices, loud noises, temperature extremes, and time-scheduled events.

For example, a motion detection event may cause a brightness level of a light of a host and nearby slave lighting devices to be increased to enhance video recording quality. When event recording concludes, the brightness level of all networked lighting device fixtures may be automatically returned to their original brightness level. A lighting device may be configured with a scheduling feature that can turn on or turn off lights at set times every day or according to brightness level options at any time of day. The scheduling feature can be repetitive (e.g., every day), selective (e.g., for selected days) allowing different schedules for each day or different weekday/weekend schedules or on specific days (e.g., off during scheduled 4th of July evening fireworks shows).

As one example, a common configuration sets a light level to normal brightness at a specific time in early darkness, then reduces the light level at midnight (or to progressively lower levels throughout the night), finally turning the light off at daybreak. As one example, control options for a lighting device may include: on or off; 20%, 33%, 66%, or normal brightness (normal according to a rated wattage of a lighting unit); 25% above rated wattage for brief periods to enhance photometric performance during video recording; a flash pattern, where individual LED panels are illuminated sequentially to attract attention or to signal a response to any of the lighting device user interaction features (e.g., motion detection, callbox buttons, etc.); a strobe feature, where the light level is increased to 100% or 150% for brief flashes simulating flash photography to attract attention and signal intruder presence detection; and photocell enable and override to allow lighting commands during daylight periods where the photocell would otherwise force LED panels off. All of the modes can be initiated either automatically via a lighting device event-action processor (EAP) or manually via built-in Web controls.

In one or more embodiments, all manual or automatic mode selections override previous selections and become the new default mode. For example, if a light is set to 66% manually and a command that temporarily increases brightness (e.g., the strobe command), the brightness returns to 66% when the strobe cycle completes. Similarly, the photocell control, when enabled, may override any manual settings, but the most recently executed lighting command takes effect once the photocell signals darkness. For example, if 66% illumination is selected (manually or via the EAP) during daylight hours with photocell control enabled, the light will remain off until the photocell senses darkness. In one or more embodiments, the motion detection feature detects motion directly from a video frame, in contrast with the familiar but imprecise PIR approach. In this case, motion detection depends on adequate lighting to ensure reliable detection. If the camera-view area is illuminated solely by a lighting device or other variable-intensity lighting it is possible to reduce the light level to a point below the minimum threshold for reliable motion detection.

It should be appreciated that that IP-enabled third party applications can also be employed to control illumination of a lighting device via IP commands. Those can be either via standard HTTP 1.0 scripting techniques or via programmed incoming IP Messages directed to the an EAP of a lighting device. In general, the approaches provide a great deal of flexibility in command structures, which simplifies the integration of energy and light level management into VMS systems, building energy management systems, alarm/intrusion systems, etc.

According to one or more aspects, each lighting device of a lighting device grid maintains a lighting control group (LCG) list of other members of the grid (e.g., nearest neighbors within, for example, a radius of 100 meters, 300 meters, or +50 yards of a GPS coordinate, or a predefined neighborhood or “spot” (e.g., a visitors' parking lot at the XYZ College Football Stadium, the area surrounding a select dorm or classroom building on campus, the intersection of Broad and Main Streets, the 300 yards of sidewalk between two buildings, or the sidewalk in front of the retail store, street-level egress points at a subway stop, a bus route, etc.). In general, the LCG list enumerates controllable devices available to a user. For example, data in the database may include IP addresses, GPS locations, Zigbee or other device addresses, routing information for bridging between sub-grids, object tracking/analytic data (e.g., license plate database for stolen autos, “Amber Alerts”, etc.), sensor or connected device provisioning, reboot, or calibration data, user-friendly information and cross-reference data, such as a device network name, and metadata including GPS coordinates, physical location details, nearest “panic box”, device serial numbers, install date, run-time, nearest CBRNE sensors, etc.

In various embodiments, controlled devices are usually in a same local area. In general, a trigger event that causes a change in lighting is likely to be of interest only in an immediate area of a controlling unit's camera but it can be directed elsewhere to alert other users (or systems) of the trigger event. For example, a flashing light (signaling a public safety officer) may indicate that a car parked beneath a lighting device has been parked too long in a no parking/no stopping zone at an airport, that a parking fee has expired for the car in a metered parking spot, the car has been parked for longer than some designated time period, or the car parked beneath the lighting device has been reported as stolen (e.g., determined in conjunction with license plate recognition analytics and a stolen car license file stored in an accessible database, etc.). As another example, every lighting device on a college campus can “flash” to indicate a campus-wide “lock down warning” (and may be accompanied by a pre-recorded warning message stored and played on a public announcement (PA) speaker managed by a lighting device). A given lighting device may select lighting devices within a determined or pre-selected zone to flash with a different pattern and/or frequency to indicate a “hotspot” or alert zone (and may be accompanied by a PA warning to evacuate the zone).

As yet another example, a person may push a “panic button” of a callbox that is associated with a lighting device to initiate flashing of a light to visually indicate an alarm location and signal an emergency response location. When a vehicle or a person enters a restricted zone after dark an object analytic may trigger an alarm and send a message to security personnel while locally flashing a light of an associated lighting device and providing a message (e.g., via a PA system) to warn the intruder of entry into the restricted zone. In general, analytics can metatag an object of interest (e.g., a 5′ 4″ blond-haired woman wearing a green jacket & blue jeans & white sneakers, or a 2010 blue one ton Ford truck). The metatag data can then be published to all nearest neighbor lighting devices along sidewalks or an area or street grid to “watch” for the specific object. As the object is identified by each successive lighting device, the lighting device may publish the metatag data to its nearest neighbors. In this manner, objects may be tracked by a grid of lighting devices and the movement of the object may be recorded as the object navigates (e.g., zigzagging) through a city. In this case, each lighting device that positively identifies the object reports (e.g., using an IP message) the occurrence of the object and may also begin flashing a light of the lighting device to visually aid someone that is trailing the object, as the object traverses the city.

Object analytics can be initiated responsive to alarms or positive readings from a chemical, biological, radiation, nuclear, or explosive (CBRNE) sensor that is networked (wireless or wired) to a lighting device. In this manner, an object that includes a triggering material may be tracked regardless of the number of “hand-offs” between vehicles or people as it moves through a lighting device grid. RFID tags can also be identified and tracked for “tagged objects, vehicles, or persons (e.g. embedded in an event badges) with the mounting of RFID readers on the lighting devices, e.g. RFID tags on vehicles for city vehicles, bus and transit vehicles, police, fire, ambulance personnel and vehicles, even tracking select vehicles that can be driven into a city on select days of a week or month. Crowd behavior analytics can be used to warn of adverse individual or crowd behavior (e.g., clustering, running, shouting, loud noises, violent behavior, etc). Telematic applications may include wirelessly reading a fleet vehicle's central processing unit (CPU) to assess maintenance and fuel requirements, etc.

It should be appreciated that membership in a lighting device group is not necessarily local, as a database that maintains IP addresses for configurable devices can be accessed by any networked lighting device. An intrusion event, for example, may be something that is sent to every lighting device on an entire campus for situational awareness reasons (e.g., to alert students campus-wide with flashing lights and increased illumination levels) to serve to both alert a student population and to add light for deployed security cameras, whether or not the cameras are associated with a lighting device grid. It should be appreciated that a lighting device group may include lighting devices with varying capabilities. For example, a lighting device group may include lighting devices that are fully-equipped and lighting devices that have lighting controls but omit cameras (surveillance) and/or other sensors. Lighting units that omit cameras are essentially slave lights that respond to select commands received from a fully-equipped lighting device.

In general, group database membership can include any networked device. For example, group commands can be customized for transmission of IP messages to third-party products, e.g., building management systems (to turn on lights inside buildings, or lock-down doors and gates, for example), or any device that can receive a standard HTTP notification message. It should be appreciated that a wide variety of user interfaces (UIs) may be utilized to create a membership database and configure actions that are initiated when any event trigger is detected. As previously mentioned, trigger events can be related to any number of events.

According to an exemplary embodiment, exemplary methods set forth herein may be performed by an exemplary one or more computer processor(s) adapted to process program logic, which may be embodied on an exemplary computer accessible storage medium, which when such program logic is executed on the exemplary one or more processor(s) may perform such exemplary steps as set forth in the exemplary methods. While various embodiments of the invention have been described above, it should be understood that they have been presented by way of example only, and not limitation. Thus, the breadth and scope of the present invention should not be limited by any of the above-described embodiments. The following claims, along with equivalents thereof, are set forth to help define the invention.

Unless stated otherwise, terms such as “first” and “second” are used to arbitrarily distinguish between the elements such terms describe. Thus, these terms are not necessarily intended to indicate temporal or other prioritization of such elements. Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included with the scope of the present invention. Any benefits, advantages, or solution to problems that are described herein with regard to specific embodiments are not intended to be construed as a critical, required, or essential feature or element of any or all the claims.

What is claimed is:

1. A method of tracking objects by a grid of devices, comprising:
detecting an event with a first sensor, wherein the first sensor is coupled to a first device mounted on a first pole, wherein the first device is within the grid of devices;
triggering, based on the detected event, a second sensor to sense an object within a field of detection of the second sensor, wherein the first device comprises the second sensor;
the first device collecting data from the second sensor regarding the object;
the first device analyzing the collected data on the object;
the first device determining, based on the analyzing, a second or more devices mounted on a second or more poles located in geographically distinct locations for which the object is projected to enter the second or more devices' respective fields of detection; and
the first device instructing the second or more devices to begin capturing data on the object utilizing one or more sensors included in the second or more devices.

2. The method of claim 1, wherein the instructing further comprises:
wirelessly transmitting, from the first device, a capture signal to the second or more devices, the capture signal identifying the object.

3. The method of claim 1, wherein the triggering further comprises:
detecting one of a chemical, biological, radiation, nuclear, and explosive hazard associated with the object as the event.

4. The method of claim 1, wherein the analyzing further comprises determining a direction of motion of the object and the determining further comprises determining the second device based on the direction of motion of the object.

5. The method of claim 1, wherein the first sensor is a first camera and the first device includes a pan-tilt-zoom camera that is controlled to sense the object based on an output of the first camera, and wherein the object is a vehicle and the pan-tilt-zoom camera collects data on the object including a license plate number of the vehicle and a facial image of a driver of the vehicle.

6. The method of claim 1, further comprising:
transmitting the collected data from the respective first and second or more devices to a central repository.

7. The method of claim 1, wherein the first device includes one or more light-emitting diode panels, and wherein a view of the second sensor is substantially centered with an illumination pattern provided by the one or more light-emitting diode panels.

8. A networked grid of devices, comprising:
a first device within a networked grid of devices communicatively coupled to the networked grid of devices, each mounted on respective poles located in geographically distinct locations, wherein the first device includes a first sensor that detects events and triggers a second sensor included within the first device to sense an object within a field of detection of the second sensor, analyzing data on the object collected from the second sensor, determining, based on the analyzing, one or more devices within the networked grid of devices that are, at least partially, projected to sense the object within one or more sensor's included within the one or more devices' fields of detection, and instructing at least one of the one or more devices within the networked grid of devices to capture data on the object, identified by the first device, utilizing one or more sensors included in the at least one of the one or more devices within the networked grid of devices; and
a second device within the networked grid of devices communicatively coupled to the networked grid of devices and mounted on a respective pole located in a geographically distinct location from the first device, wherein the second device includes one or more sensors to sense an object within a field of detection of the second sensor and configured to receive instructions from the first device over the networked grid of devices to capture data on an identified object utilizing one or more sensors within the second device.

9. The networked grid of devices of claim 8, wherein:
each device within the networked grid of devices further comprising a communication device.

10. The networked grid of devices of claim 8, wherein:
each device within the networked grid of devices further comprising one or more sensors for detecting one of at least a chemical, biological, radiation, nuclear, and explosive hazard associated with an object as an event.

11. The networked grid of devices of claim 8, wherein the first device analyzes data received from at least one of the first sensor and the second sensor to determine a direction of motion of the object and determine an instruction for the second device based on the direction of motion of the object.

12. The networked grid of devices of claim 8, wherein the first sensor is a camera and the second sensor includes a pan-tilt-zoom camera that is controlled to sense the object based on an output of the camera.

13. The networked grid of devices of claim 12, wherein
each device within the networked grid of devices further comprising a communication device that wirelessly transmits a capture signal to one or more devices within the networked grid of devices instructing to sense data on an identified object.

14. The networked grid of devices of claim 8, further comprising:
each device within the networked grid of devices further comprising a communication device and wherein data collected from respective sensors by the respective first and second devices are transmitted to a central repository.

15. The networked grid of devices of claim 8, wherein the first and second devices include one or more light-emitting diode panels, and wherein a respective view of at least one respective sensor on each respective first and second devices is substantially centered with an illumination pattern provided by the one or more light-emitting diode panels.

16. A method of tracking objects with a grid of modular security and lighting devices, comprising:
triggering, based on an event, a first camera to begin capturing first images of an object, wherein the first camera is included in a first modular security and lighting device;
analyzing the captured first images of the object;
selecting, based on the analyzing, a second camera to begin capturing second images of the object, wherein the second camera is included in a second modular security and lighting device and the first and second modular security and lighting devices are located in geographically distinct locations.

17. The method of claim 16, wherein the selecting further comprises:
transmitting, from the first modular security and lighting device, a capture signal to the second modular security and lighting device, the capture signal identifying the object.

18. The method of claim 16, wherein the triggering, based on the event, further comprises:
detecting one of a chemical, biological, radiation, nuclear, and explosive hazard associated with the object; and
triggering the first camera to begin capturing the first images of the object based on the detecting.

19. The method of claim 16, wherein the analyzing further comprises determining a direction of the object and the selecting further comprises selecting the second camera based on the direction of the object.

20. The method of claim 16, wherein the first camera is a fisheye camera and the first modular security and lighting device further includes a pan-tilt-zoom camera that is controlled to obtain additional details on the object based on an output of the fisheye camera, wherein the object is a vehicle and the additional details include a license plate number of the vehicle and a facial image of a driver of the vehicle.

21. The method of claim 16, further comprising:
transmitting the stored first and second images from the respective first and second modular security and lighting devices to a central repository.

22. The method of claim 16, wherein the first modular security and lighting device includes one or more light-emitting diode panels, and wherein a view of the first camera is substantially centered with an illumination pattern provided by the one or more light-emitting diode panels.

23. A modular security and lighting device grid, comprising:
a first modular security and lighting device including a first camera that is triggered, based on an event, to capture first images of an object, wherein the first modular security and lighting device is configured to analyze the captured first images of the object; and
a second modular security and lighting device in communication with the first modular security and lighting device, wherein the second modular security and lighting device includes a second camera, and wherein the first modular security and lighting device selects the second camera to capture second images of the object based on the analysis of the captured first images, where the first and second modular security and lighting devices are located in geographically distinct locations.

24. The grid of claim 23, wherein the first modular security and lighting device further comprises:
a communication device configured to transmit a capture signal to the second modular security and lighting device, wherein the capture signal identifies the object.

25. The grid of claim 23, wherein the first modular security and lighting device further comprises:
a sensor device configured to detect one of a chemical, biological, radiation, nuclear, and explosive hazard associated with the object, wherein the first camera is triggered to begin capturing the first images of the object in response to the sensor device detecting one of the chemical, biological, radiation, nuclear, and explosive hazard associated with the object.

26. The grid of claim 23, wherein the second camera is selected based on a direction of the object.

27. The grid of claim 26, wherein the object is a vehicle and the additional details include at least one of a license plate number of the vehicle and a facial image of a driver of the vehicle.

28. The grid of claim 23, wherein the first modular security and lighting device further comprises a second transmitter configured to transmit the stored first and second images from the respective first and second modular security and lighting devices to a central repository.

29. The grid of claim 23, wherein the first modular security and lighting device further comprises:
one or more light-emitting diode panels, wherein a view of the first camera is substantially centered with an illumination pattern provided by the one or more light-emitting diode panels.
